(19) United States
(12) Patent Application Publication
(10) Pub. No.: US 2009/0008836 A1
(43) Pub. Date: Jan. 8, 2009

(54) METHOD FOR PRODUCING FIBER-REINFORCED PLASTIC COMPONENTS

(76) Inventors: Robert Kaps, Braunschweig (DE); Ing. Lars Herbeck, Feldheim (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/877,873

(22) Filed: Oct. 24, 2007

(30) Foreign Application Priority Data
Oct. 26, 2006 (DE) 10 2006 050 579.4

(51) Int. Cl. B29C 70/36

(52) U.S. Cl. 264/511

(57) ABSTRACT

For producing a joined-together fiber composite component in which mutually adjacent regions (5, 6) are constructed in different ways but are cured in a joint thermal treatment, arranged between the regions is a transitional film (8), which has a composition that differs from the compositions of the matrices of the two adjacent regions (5, 6) and which spatially separates the two adjacent regions (5, 6) in the joint thermal treatment but enters into permanent bonds with the matrices of the two adjacent regions (5, 6). The fact that the transitional film (8) is vacuumtight means that one adjacent region (5) can first be formed independently from a preform (9) and enclosed with the transitional film (8), thereby bounding certain portions, and be evacuated and infiltrated with resin (22) on its own, and the other adjacent region (6) can be formed from a prepreg (2). Following this, the two adjacent regions (5 and 6) are brought together and joined to each other, the other adjacent region (6) being sealed and the other adjacent region (6) being evacuated during the subsequent joint thermal treatment for the removal of excess air.

### FIELD OF THE INVENTION

The invention relates to a method of producing a fiber composite component. In particular, the invention relates to a method of producing a joined-together fiber composite component in which mutually adjacent regions of the fiber composite component are constructed in different ways but are cured in a joint thermal treatment.

### BACKGROUND OF THE INVENTION

A method of producing a joined-together fiber composite component is known for example from EP 1 400 341 B1 (corresponds to US patent application US 2004/0051214 A1). In this case, one region of the fiber composite component is constructed from what is known as a prepreg, while an adjacent region is constructed from what is known as a preform. While a prepreg has fibers which are already impregnated with a resin required for forming the matrix of the fiber composite component, resin still has to be injected into a preform before the two regions can be cured in a joint thermal treatment. For the injection of the resin into the preform, but also to free the prepreg of air inclusions, it is customary to evacuate a space that encloses the two adjacent regions of a preliminary form of the fiber composite component and is covered by a vacuum bag. In this case, however, there is the risk of the resin seeping out from the prepreg into the preform. As a result, the prepreg may later have a lack of resin. Furthermore, a spatially undefined transition between the resin of the prepreg and the resin that is injected into the preform may occur in the region of the preform. This can lead to problems, for example with the approval of aircraft components that are based on defined product specifications. Moreover, the resin of the prepreg and the resin that is injected into the preform must be fully compatible and bond with each other, in order that the regions of the prepreg and of the preform become permanently joined to each other in the finished fiber composite component. As a result, many resin combinations, such as for example polyester resin on the one hand and epoxy resin on the other hand, are ruled out. To strengthen the transition between the regions of the prepreg and of the preform, it is known to provide additional mechanical connecting elements, which reach from one region into the other region. It is also known from EP 1 400 341 B1 to provide an adhesive film between the prepreg and the preform, in order to improve the bond between the two regions.

A further method of producing a joined-together fiber composite component is known from EP 1 444 090 B1 (corresponds to US patent application US 2004/0265406 A1). Here, too, the two mutually adjacent regions are formed by a prepreg on the one hand and a dry textile semifinished product, i.e. a preform, on the other hand, certain portions of which lie against one another. As a special feature, here a first chamber is formed around the prepreg and a second chamber is formed around the preform by means of gas-permeable membranes, an injection line for the injection of the resin opening out into the chamber with the semifinished textile product. In this case it is also intended to be possible for the surface of the preform or of the prepreg to form the boundary of one chamber or the other, and it is also intended that the membranes that define the chambers, and are in any event gas-permeable, not only may be resin-permeable but also may be resin-impermeable. However, it is not explained how a resin-impermeable membrane could be formed by parts of the prepreg or of the preform.

A method of producing a joined-together fiber composite component in which mutually adjacent regions of the fiber composite component are constructed in different ways but are cured in a joint thermal treatment, wherein a vacuumtight transitional film is arranged between the regions, wherein the transitional film has a composition that differs from the compositions of the matrices of the two adjacent regions, wherein the transitional film spatially separates the two adjacent regions in the joint thermal treatment but enters into permanent bonds with the matrices of the two adjacent regions, wherein at least one evacuation region, enclosing one of the two adjacent regions, is bounded at least in certain portions by the transitional film and wherein two evacuation regions enclosing the two adjacent regions are evacuated in different ways, is known from U.S. Pat. No. 6,048,488 A. This method is referred to as CIRTM (co-injection resin transfer molding). In the case of this method, a transitional film is arranged between the mutually adjacent regions and separates two preforms in the mutually adjacent regions from each other, in order that resins for infiltrating the two preforms in the course of the joint thermal treatment can be injected into the two mutually adjacent regions in different ways. This method is suitable for complex structures in the two mutually adjacent regions. However, the formation based on a preform is very complicated for a simply structured region of a large surface area on one side of the transitional film.

### SUMMARY OF THE INVENTION

The invention provides a method of producing a joined-together fiber composite component with two regions that are mutually adjacent but constructed in different ways, which respectively have reinforcing fibers embedded in a matrix and arranged between which is a transitional film which has a composition that differs from the compositions of the matrices of the two mutually adjacent regions, wherein the method has the steps of: first separately preparing one of the mutually adjacent regions from a preform, wherein the step of preparing one of the mutually adjacent regions has the substeps of: enclosing the preform in a first vacuumtight covering, wherein at least a portion of the covering is formed by the transitional film, evacuating the preform in the first covering, and infiltrating the preform in the first covering with resin; preparing the other of the adjacent regions from a prepreg; joining together the mutually adjacent regions, wherein the step of joining together has the substeps of: arranging the prepreg on the transitional film and enclosing the prepreg in a second vacuumtight covering, wherein at least a portion of the covering is formed by the transitional film; and jointly thermally treating the two prepared adjacent regions, in order to thermally cure them jointly, wherein the prepreg is evacuated for the removal of excess air and wherein the transitional film spatially separates the two adjacent regions, but enters into permanent bonds with the matrices of the two adjacent regions.

In the case of the novel method, a transitional film is arranged between the regions that are differently constructed, this being intended to mean any differences in the construction and not just a prepreg on the one hand and a preform on the other hand. A transitional film is intended to mean here such a film that spatially separates the two adjacent regions of different construction from each other also in the finished fiber composite component. At the same time, however, the transitional film provides a permanent connection between the two adjacent regions. For this purpose, it has a composition that does indeed differ from the compositions of the matrices of the two adjacent regions, but enters into permanent bonds with the matrices of the two adjacent regions during the joint thermal treatment. The two adjacent regions may be constructed completely independently of each other, in particular with respect to the composition of the resins forming their matrices. There is no need to pay any consideration to compatibilities between the resins, as long as they can in each case enter into permanent bonds with the transitional film.

The transitional film not only prevents resin from passing between the two adjacent regions of different construction, at least substantially, but is additionally also vacuumtight. The vacuum tightness of the transitional film makes completely separate steps possible when constructing the two adjacent regions before the final joint thermal treatment. Therefore, the prepreg and the preform may be arranged in the two regions, evacuated, optionally infiltrated with resin and also prehardened by thermal pretreatment at different points in time. Apart from entirely different compositions of the resins on the two sides of the transitional film, entirely different levels of negative pressure are also possible, for example a low level of negative pressure for outgassing a large prepreg on the one hand and a high level of negative pressure for preparing the infiltration of a smaller preform on the other hand. By dividing the production of the fiber composite component into individual, separable steps, the complexity of the production overall is distinctly reduced. The method according to the invention is suitable in particular for more complex attachments to regions of a large surface area that are in fact simply structured.

Parts of the transitional film that initially protrude beyond the contact region with the two adjacent regions may be removed after the joint thermal treatment. Where the transitional film is to be removed again, a release film or so-called peel ply must be arranged between it and the region adjacent to it only on one side.

As already repeatedly mentioned, the transitional film is noticeably present between the mutually adjacent, differently constructed regions even in the finished fiber composite component.

The transitional film may, for its part, be fiber-reinforced, in order for example to be better able to withstand different pressures on both its sides even at relatively high temperatures. In this case, the reinforcing fibers of the transitional film may protrude beyond its surfaces, in order to provide an additional possibility for bonding to the matrices of the two adjacent regions.

The transitional film is preferably formed from amorphous thermoplastics, at least at its surfaces. It is known of some amorphous thermoplastics that they enter into good bonds with the chemically harder resins that are usually used for fiber composite components.

In practice, the transitional film may be formed at its surfaces from PEI (polyether imide). PEI is attacked by many customary resins for producing fiber composite components, whereupon reciprocal diffusion into the material occurs and the formation of a mixing zone, which after its curing provides a permanent bond.

The two surfaces of the transitional film facing the two adjacent regions do not have to be composed in the same way. Rather, different compositions are also possible here, in order to adapt the transitional film optimally to matrices of different compositions in the two regions. This makes it possible to use completely different resins on the two sides of the transitional film, such as for example polyester resin on the one hand and an epoxy resin on the other hand, which though not compatible with each other are respectively compatible with the composition of the transitional film at its surface facing them, in order nevertheless to achieve a permanent bond of the two regions adjacent to the transitional film in the finished fiber composite component.

In a middle layer, the transitional film is preferably formed from PEEK, in order to achieve not only high strength but also high resistance to the attack by the resins from the adjacent regions. PEEK is a high-quality plastic that is known to be highly resistant and often is only not used for reasons of cost. In the case of the present invention, this high-quality plastic is used at the decisive location, but only in a small amount, in order to maximize the integrity of the transitional film during the thermal treatment for curing the resins.

Advantageous developments of the invention emerge from the patent claims, the description and the drawings. The advantages of features and of combinations of more than one feature that are mentioned in the introductory part of the description are only given by way of example and may have an effect alternatively or cumulatively, without the advantages necessarily having to be achieved by embodiments according to the invention. Further features can be taken from the drawings—in particular the represented geometries and relative dimensions of a number of components in relation to one another and their relative arrangement and operative connection. It is likewise possible for features of different embodiments of the invention or features of different patent claims to be combined in ways other than the chosen way in which the patent claims refer back to one another, and is hereby suggested. This also refers to those features that are represented in separate drawings or are mentioned in the description of the latter. These features may also be combined with features of different patent claims. Similarly, for further embodiments of the invention, features that are presented in the patent claims may be omitted.

### BRIEF DESCRIPTION OF THE FIGURES

The invention is explained in more detail and described below on the basis of exemplary embodiments with reference to the accompanying figures.

FIG. 1 shows a section through the preliminary form of a fiber composite component with two mutually adjacent regions comprising a prepreg on the one hand and a preform on the other hand.

FIG. 2 schematically shows a first step of a thermal treatment for curing the fiber composite component.

FIG. 3 schematically shows a second step of the thermal treatment for curing the fiber composite component.

FIG. 4 schematically shows the demolding of the finished fiber composite component; and

FIG. 5 shows a section through an alternative preliminary form of a fiber composite component with two mutually adjacent regions comprising preforms.

FIG. 6 shows a section through a further alternative preliminary form of a fiber composite component that does indeed have two mutually adjacent regions, as in FIG. 1, comprising a prepreg on the one hand and a preform on the other hand, but has a different delimitation of the two regions from each other.

FIGS. 7 to 10 show, in four steps, the formation according to the invention of a preliminary form of a fiber composite component, again as in FIG. 1 with two mutually adjacent regions of a prepreg on the one hand and a preform on the other hand; and

FIG. 11 schematically shows the thermal treatment for curing the fiber composite component from the preliminary form as shown in FIG. 10.

### DETAILED DESCRIPTION

In the preliminary form 1 for a fiber composite component as shown in FIG. 1, a prepreg 2 is arranged on a mold 3. Arranged on the prepreg 2 are a peel ply 21 and a release film 4, which have cutouts 7 in a contact region with a region 5 other than the region 6 of the prepreg 2. Arranged on the release film 4 in such a way as to cover the cutouts 7 completely is a transitional film 8. Arranged on the transitional film 8, in the region 5 which lies entirely over the cutout 7 is a preform 9. The region 5 of the preform 9 is sealed with a vacuumtight membrane 10 by means of a peripheral seal 11 with respect to the transitional film 8. Since the transitional film 8 is also vacuumtight, the region 5 can be separately evacuated by way of a connection 12. Arranged over the entire preliminary form 1 on the mold 3 is a vacuum bag 13, which is sealed with respect to the mold 3, which for its part is vacuumtight, by means of a peripheral seal 14. The interior space delimited in this way, which is effectively the region 6 of the prepreg 2, can be evacuated by way of a connection 15.

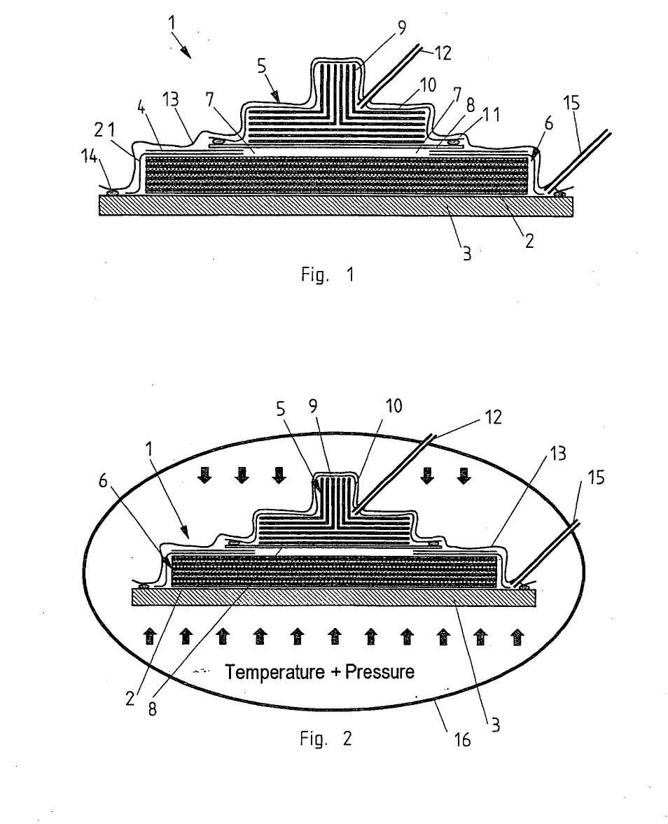

FIG. 2 schematically shows the preliminary form 1 on the mold 3 under the vacuum bag 13 once it has been introduced into an autoclave 16. Elevated temperature and elevated pressure prevail in the autoclave 16. By simultaneous evacuation of the regions 5 and 6 by way of the connections 12 and 15, not only is the difference in pressure increased by way of the vacuum bag 13 or the membrane 10, but gas which would disturb the construction of the desired fiber composite component is also removed from the regions 5 and 6. In the region 6, a lower negative pressure is sufficient for removing excess gas, which predominantly originates from air inclusions between individual prepreg layers, in order to form a fiber-reinforced polymer matrix there, because the prepreg 2 not only has reinforcing fibers but also already has resin for forming the matrix. By contrast, the reinforcing fibers of the preform 9 have no resin, or in any event not amounts adequate for matrix formation. Therefore, the region 5 must first be evacuated to a greater negative pressure before resin 22 can be injected by way of the connection 12 or another connection, in order to fill the previously created vacuum again.

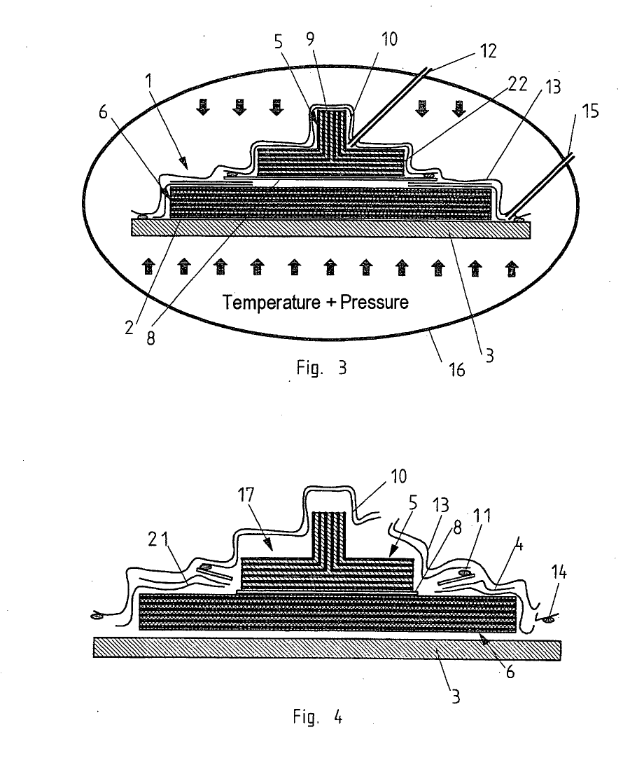

In the course of the further thermal treatment, which is indicated in FIG. 3, this resin 22 then hardens in the autoclave 16 in a way similar to the resin in the region 6 to form a fiber-reinforced matrix. In addition, during the thermal treatment, bonds are created between the transitional film 8 and the regions 5 and 6 adjacent to it, in that the transitional film enters into permanent bonds with the matrices of the two adjacent regions 5 and 6. To be able to enter into these bonds, the matrix of the transitional film 8 consists, at least at its surface, of amorphous thermoplastics, in particular PEI (polyether imide).

FIG. 4 shows the demolding of the finished fiber composite component 17 after the thermal treatment in the autoclave 16. The connections 12 and 15 have already been removed. The vacuum bag 13 and the membrane 10 as well as the seals 11 and 14 are also removed. In addition, the parts of the transitional film 8 that are located above the release film 4 and have correspondingly not bonded to the adjacent region 6 are cut off and removed together with the release film 4. Subsequently, the fiber composite component 17 can be freely removed from the mold 3. In the fiber composite component 17, the regions 5 and 6 are permanently joined together by way of the transitional film 8.

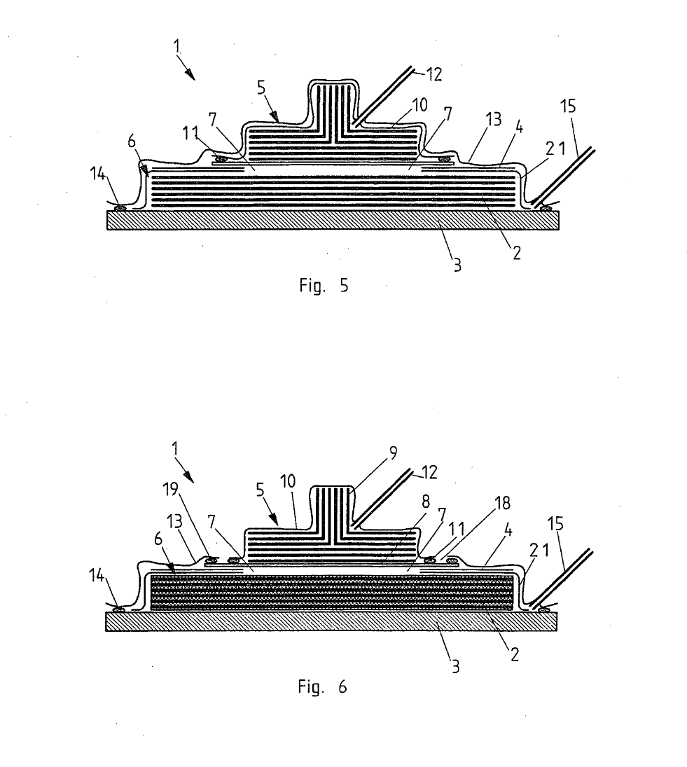

The preliminary form 1 drawn in FIG. 5 is constructed in principle in the same way as the preliminary form 1 as shown in FIG. 1, the only difference being that here the region 6 also contains a preform 20, which is intended for infiltration with a resin. This resin may differ from the resin 22 for infiltrating the preform in the region 5, for example with regard to its composition.

In the case of the preliminary form 1 drawn in FIG. 6, which like the preliminary form 1 as shown in FIG. 1 has a prepreg 2, by contrast with FIG. 1 the vacuum bag 13 does not cover over the region 5 in addition to the region 6, but instead has for the region 5 a cutout 18, around which it is sealed with respect to the transitional film 8 by way of a seal 19. Especially in the case of regions 6 that cover very large surface areas and are largely level, this procedure facilitates a smooth coverage with the vacuum bag 13, even if individual regions 5 that disturb the level progression of the region 6 are provided. In the case of the preliminary form 1, two completely separate evacuation regions are correspondingly provided in the form of the regions 5 and 6, which are respectively partially bounded by the transitional film 8 and are also delimited with respect to each other in the region of the cutout 7 by the transitional film 8.

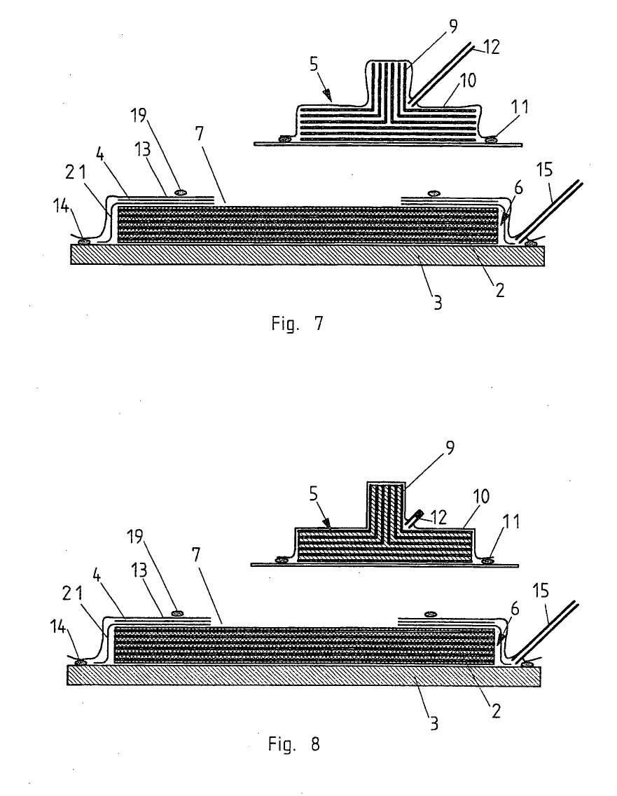

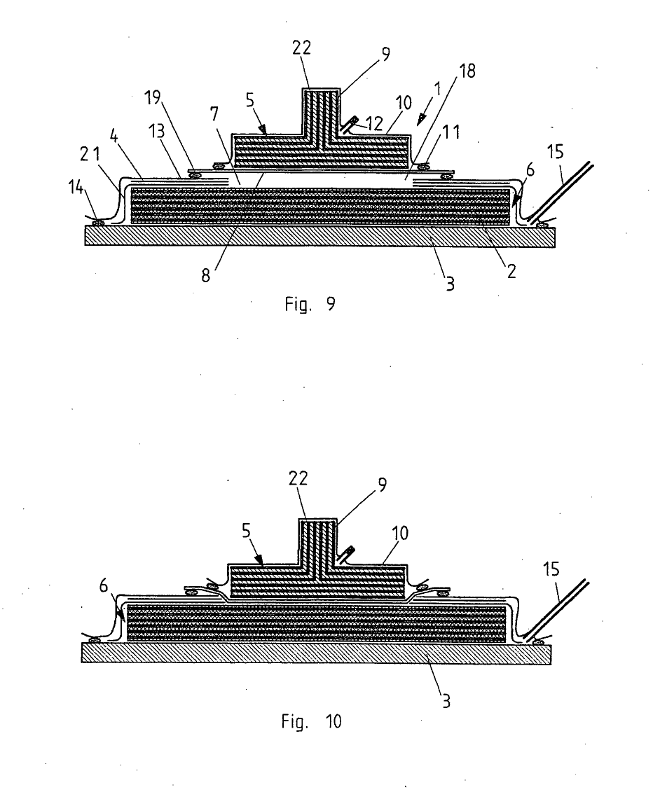

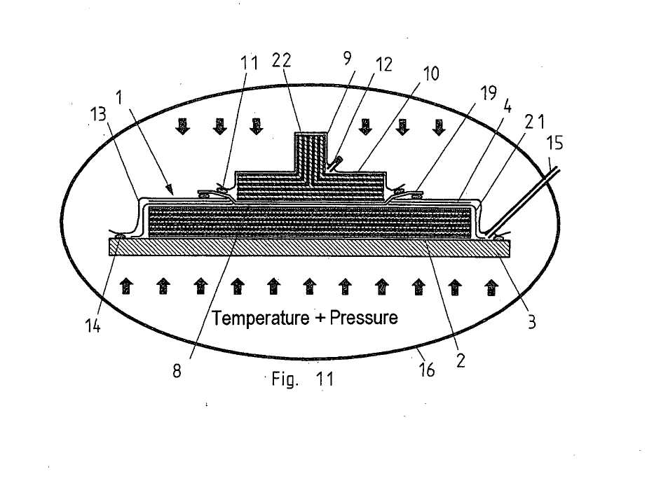

Therefore, the region 6 can also be already evacuated and optionally prehardened before it is put together with the region 5. This is drawn in the following FIGS. 7 to 10. FIG. 7 shows how the region 5 is first formed independently from the preform 9 and enclosed with the transitional film 8 and the membrane 10, with the seal 11 in between. Therefore, the region 5 can be evacuated and infiltrated with the resin 22 on its own, which is indicated in FIG. 8. A thermal treatment of the region 5 for the preliminary curing of the resin 12 may also already take place. Only after that are the regions 5 and 6 brought together and joined to each other as shown in FIGS. 9 and 10. Consequently, the region 6, which is initially still open through the cutouts 18 in the vacuum bag 13, is then also sealed, so that it can be evacuated in the subsequent thermal treatment in the autoclave 16 as shown in FIG. 11 for the removal of excess air. The procedure described on the basis of FIGS. 7 to 11 allows more complex attachments to regions 6 of a large surface area that are in fact simply structured first to be individually prepared and only connected to the region 6 before the final thermal treatment in the autoclave 16.

### LIST OF DESIGNATIONS

1 preliminary form
2 prepreg
3 mold
4 peel ply
5 region
6 region
7 cutout
8 transitional film
9 preform
10 membrane
11 seal
12 vacuum connection
13 vacuum bag
14 seal
15 vacuum connection
16 autoclave
17 fiber composite component
18 cutout
19 seal
20 preform
21 peel ply
22 resin

1. A method of producing a joined-together fiber composite component with two regions that are mutually adjacent but constructed in different ways, which respectively have reinforcing fibers embedded in a matrix and arranged between which is a transitional film which has a composition that differs from the compositions of the matrices of the two mutually adjacent regions, wherein the method has the steps of:
first separately preparing one of the mutually adjacent regions from a preform, wherein the step of preparing one of the mutually adjacent regions has the substeps of:
enclosing the preform in a first vacuumtight covering, wherein at least a portion of the covering is formed by the transitional film,
evacuating the preform in the first covering, and
infiltrating the preform in the first covering with resin;
preparing the other of the adjacent regions from a prepreg;
joining together the mutually adjacent regions, wherein the step of joining together has the substeps of:
arranging the prepreg on the transitional film and
enclosing the prepreg in a second vacuumtight covering, wherein at least a portion of the covering is formed by the transitional film; and
jointly thermally treating the two prepared adjacent regions, in order to thermally cure them jointly, wherein the prepreg is evacuated for the removal of excess air and wherein the transitional film spatially separates the two adjacent regions, but enters into permanent bonds with the matrices of the two adjacent regions.

2. The method as claimed in claim 1, wherein the step of preparing one of the mutually adjacent regions has the further substep of precuring the resin with which the preform has been infiltrated.

3. The method as claimed in claim 1, which has the further step of removing such parts of the transitional film that do not have any contact with the two adjacent regions after the joint thermal treatment.

4. A method of producing a joined-together fiber composite component with two regions that are mutually adjacent but constructed in different ways, which respectively have reinforcing fibers embedded in a matrix and arranged between which is a transitional film which has a composition that differs from the compositions of the matrices of the two mutually adjacent regions, wherein the method has the steps of:
first separately preparing one of the mutually adjacent regions from a preform, wherein the step of preparing one of the mutually adjacent regions has the substeps of:
enclosing the preform in a first vacuumtight covering, wherein at least a portion of the covering is formed by the transitional film,
evacuating the preform in the first covering,
infiltrating the preform in the first covering with resin; and
precuring the resin with which the preform has been infiltrated;
preparing the other of the adjacent regions from a prepreg;
joining together the mutually adjacent regions, wherein the step of joining together has the substeps of:
arranging the prepreg on the transitional film and
enclosing the prepreg in a second vacuumtight covering, wherein at least a portion of the covering is formed by the transitional film; and
jointly thermally treating the two prepared adjacent regions, in order to thermally cure them jointly, wherein the prepreg is evacuated for the removal of excess air and wherein the transitional film spatially separates the two adjacent regions, but enters into permanent bonds with the matrices of the two adjacent regions.
